(19) United States
(12) Patent Application Publication
(10) Pub. No.: US 2026/0178967 A1
(43) Pub. Date: Jun. 25, 2026

(54) TRAINING MACHINE-LEARNING MODEL TO GENERATE AN EMBEDDING FOR AN ONLINE SESSION

(71) Applicant: Maplebear Inc., San Francisco, CA (US)

(72) Inventors: Venkata Satya Pradeep Karuturi, Los Angeles, CA (US); Vibhhu Sharma, Pittsburgh, PA (US); Shishir Kumar Prasad, San Ramon, CA (US)

(21) Appl. No.: 19/000,414

(22) Filed: Dec. 23, 2024

(51) Int. Cl. G06N 20/00; G06F 16/9538; G06Q 30/0601

(52) U.S. Cl. CPC G06N 20/00; G06F 16/9538; G06Q 30/0633

(57) ABSTRACT

An online system trains a machine-learning model to generate an embedding in real time for a current session of a user with the online system. The machine-learning model is trained by applying a masked language modeling algorithm to training data including a training sequence of actions and a masked action to predict a user’s action that follows the training sequence of actions. The online system captures current session data describing a sequence of actions of the user performed during the current session. The online system applies the trained machine-learning model to predict a next user’s action and generate a session embedding that encodes information about the sequence of actions and the next action. Using the session embedding, the online system ranks a list of objects. The online system generates a user interface signal causing a user’s device to display a user interface with the ranked list of objects.

### BACKGROUND

An online system may allow its users to interact with items, e.g., by placing online orders for the items. To provide more relevant content to users, it may be useful to characterize a user’s current session with the online system. For example, information about a user’s current session may be useful for ranking and selecting content to show to the user during the session. This is because content that is relevant to a current session may have better contextual relevance to the user’s current interest. Contextual relevance about a user’s session may also be useful in situations where the online system does not keep information about a user’s profile, such as when the user is not logged in, the user is new at the online system, or the user has otherwise opted for higher privacy. In such cases, information gleaned from the user’s current session may be the only thing that the online system knows about the user.

Therefore, there is a technical problem of how to automatically and in real time characterize current sessions of users of the online system, and then use that characterization to present useful content to the user.

### SUMMARY

Embodiments of the present disclosure are directed to training a machine-learning model of an online system to generate an embedding in real time for a session of a user with the online system.

In accordance with one or more aspects of the disclosure, the online system receives, via a network and from a device associated with a user of the online system, current session data describing a sequence of actions of the user performed during a current session of the user at the online system. The online system accesses a session embedding machine-learning model of the online system, wherein the session embedding machine-learning model is trained by: retrieving, from a database of the online system, training data describing a training sequence of actions of the user performed during a past session of the user at the online system, generating a label for the training data such that the label represents a masked action of the user performed during the past session, the masked action following the training sequence of actions, applying the session embedding machine-learning model to perform a masked language modeling machine-learning algorithm to the training data including the label to predict an action of the user performed during the past session, the predicted action following the training sequence of actions, and updating, using the label and the predicted action, a set of parameters of the session embedding machine-learning model. The online system applies the session embedding machine-learning model to the current session data to predict a next action of the user to be performed during the current session, the next action following the sequence of actions, and generate a session embedding that encodes information about the sequence of actions and the next action. The online system ranks, using the session embedding and information about the user, a list of objects to generate a ranked list of objects. The online system generates, using information about the ranked list of objects, a user interface signal. The online system sends, via the network, the user interface signal to the device associated with the user, wherein the sending the user interface signal causes the device associated with the user to display a user interface with the ranked list of objects.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3A illustrates an example architectural flow diagram of training a machine-learning model of an online system to generate an embedding for a session of a user with the online system, in accordance with one or more embodiments.

FIG. 3B illustrates an example architectural flow diagram of using a machine-learning model of an online system to generate in real time an embedding for a session of a user with the online system, in accordance with one or more embodiments.

FIG. 4 illustrates an example architectural flow diagram of a real-time pipeline that continually feeds a user’s actions into the trained machine-learning model and updates the current session embedding in a feature store for other machine-learning models of an online system, in accordance with one or more embodiments.

FIG. 5 is a flowchart for a method of training and using a machine-learning model of an online system to generate a session embedding, in accordance with one or more embodiments, in accordance with one or more embodiments.

### DETAILED DESCRIPTION

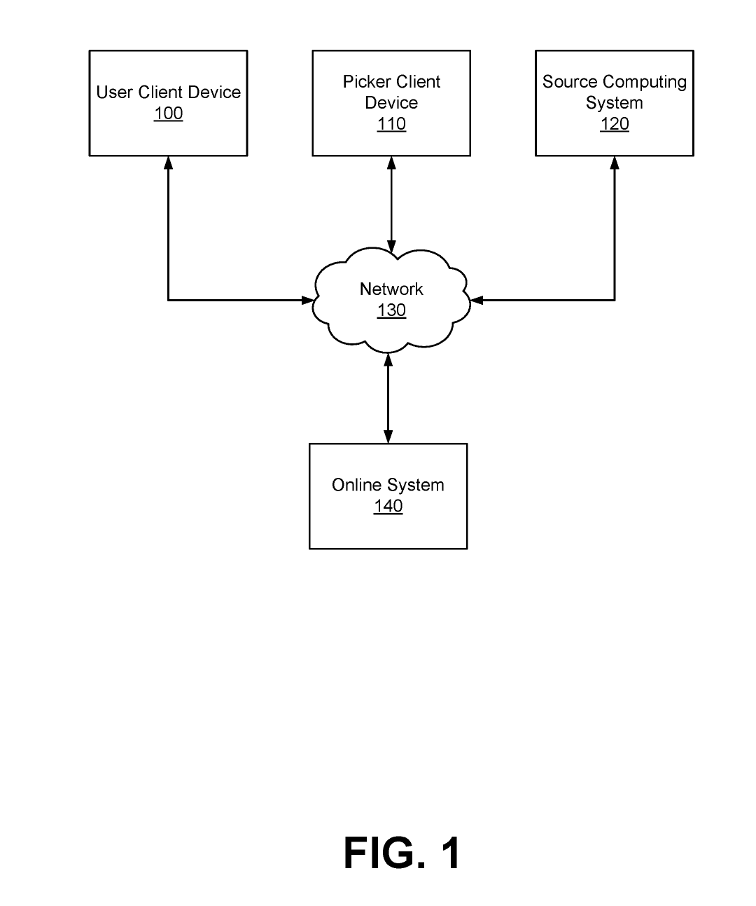

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker (i.e., fulfillment agent, servicing agent, or agent) that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a source location. The user’s order may specify which groceries they want to be delivered from the source location and the quantities of each of the groceries. The user client device 100 transmits the user’s order to the online system 140 and the online system 140 selects a picker to travel to the source location to collect the groceries ordered by the user. The online system transmits an offer to the picker for the picker to service the order in exchange for consideration and, if the picker accepts the offer, the picker collects the groceries from the source location. Once the picker has collected the groceries ordered by the user, the picker delivers the groceries to a location transmitted to the picker client device 110 by the online system 140.

The online system 140 characterizes a user’s current session with the online system 140 using a session embedding. The session embedding is a numerical vector representation of the user’s shopping journey during a session at the online system 140, i.e., a sequence of user’s interactions with the online system 140 during the session. A value of each vector dimension in the session embedding is an identifier of a corresponding user’s interaction with the online system 140 among the sequence of interactions. An example session embedding can be represented with the 128-dimensional vector [0.3. 0.25 … 0.4]. The session embedding can capture information from adding items in a cart, user searches, product views, etc. A session at the online system 140 is an arbitrary window of time where a user interacts with the online system 140 (e.g., adds any item to a cart, conduct searches, etc.) within a defined time period (e.g., two hours) of the last user’s interaction of the online system 140 (e.g., the last cart add) that belongs to a previous user’s session at the online system 140.

To generate a session embedding for a given session, the online system 140 trains a session embedding machine-learning model (e.g., transformer model or transformer network) using training data that describes a sequence of actions of one or more users in one or more previous sessions. The online system 140 trains the session embedding machine-learning model to predict user’s actions based on sequences of previous user’s actions using masked language modeling. Once the session embedding machine-learning model is trained, the online system 140 generates a session embedding for a given session by feeding the user’s actions during the session into the session embedding machine-learning model and then by extracting the session embedding from an intermediate layer of the session embedding machine-learning model (e.g., intermediate layer of the transformer network). In this manner, the session embedding machine-learning model may create real time representations of users as they go through their shopping sessions with the online system 140. By leveraging high intent signals from a user such as adding items to a cart and search queries, the session embedding machine-learning model may generate a session embedding that captures in real time the user’s evolving intent.

The session embedding may be updated in real time with every user’s interaction with the online system 140 (e.g., cart add, user’s search, product view, etc.) and may be available in a feature store of the online system 140. The session embedding may capture the latent intent of the user that can be utilized in downstream applications of the online system 140 to better serve the user’s intent. In one or more embodiments, the session embedding can be used as an input feature for item ranking machine-learning models to provide contextual information to those machine-learning models. Other downstream application that can utilize the session embedding as an input feature may include ads response prediction machine-learning models, whole page rankers, search models, some other models, or some combination thereof. To reduce a latency, a real-time pipeline may continually feed identifiers of user’s actions into the session embedding machine-learning model and update the current session embedding in the feature store for the other machine-learning models.

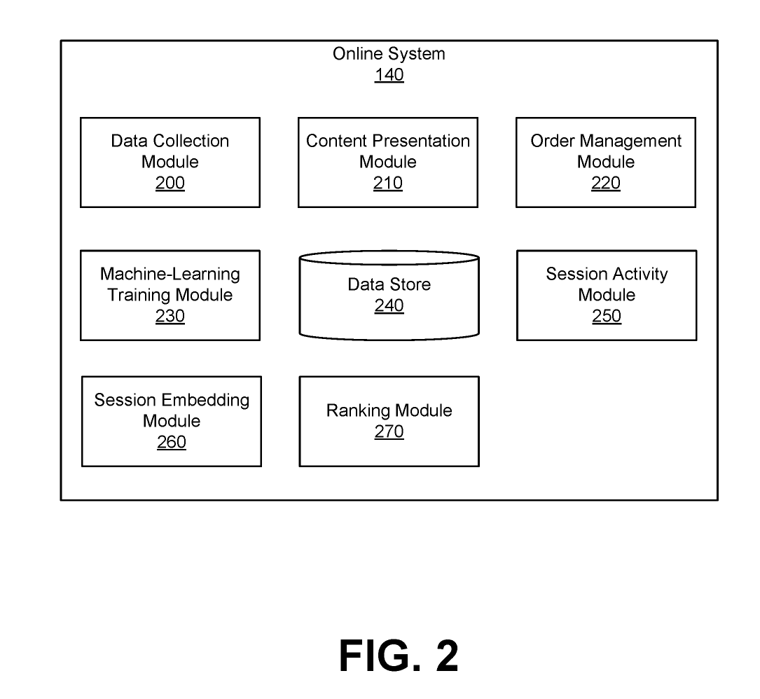

Using past sequences of high intent user’s actions from a shopping session, the session embedding machine-learning model is trained to learn a representation of the user’s shopping journey, i.e., the session embedding. The online system 140 may leverage language models (e.g., large language models (LLMs)) to generate initial values for some parameters of session embedding machine-learning model. At run time of the trained session embedding machine-learning model, the online system 140 utilizes a real time pipeline that updates the session embedding in real time and provides the updated session embedding for real time use in downstream applications. Using the real time representation of the current user’s session, the online system 140 can better utilize the downstream models, such as ads and search response prediction models. This may translate into additional ads revenue for the online system 140 and sources. Additionally, applying the session embeddings to, e.g., the whole page ranker and item ranking models, may translate to more ad revenue and gross transaction values (GTVs) for the online system 140 and sources. From the user standpoint, users can get more relevant recommendations. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a session activity module 250, a session embedding module 260, and a ranking module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The session activity module 250 may capture data describing a sequence of actions of a user of the online system 140 during a current session of the user with the online system 140. The sequence of actions may include adding items to a cart, search queries, product views, etc. The session activity module 250 may receive the data describing the sequence of actions in real time from the user client device 100 via the network 130. The session activity module 250 may store the captured data in a non-transitory computer-readable medium of the session activity module 250, and may provide the captured data as input signals to a session embedding model.

The session embedding module 260 may access the session embedding model (e.g., machine-learning model) that is trained to generate a session embedding for the user’s current session. The session embedding module 260 may deploy the session embedding model to run a machine-learning algorithm to input signals to output the session embedding. A set of parameters for the session embedding model may be stored at one or more non-transitory computer-readable media of the session embedding module 260. Alternatively, the set of parameters for the session embedding model may be stored at one or more non-transitory computer-readable media of the data store 240.

The machine-learning training module 230 may perform initial training of the session embedding model by applying the masked language modeling technique. This technique is known for natural language processing (NLP) modeling, where an existing sentence is taken as an input and have the model predicting next words. The session embedding model may be trained using the masked language modeling technique to predict a next user’s action based on a sequence of user’s actions input into the session embedding model. A user’s action may be a specific interaction with an object, such as adding item A to a cart, search with query B, view product details of item C, etc. Training data for the session embedding model may be sequences of user actions (e.g., user cart adds, search queries, product views, etc.) performed during past sessions with the online system 140, where each label is a specific masked action within a sequence of user actions. The machine-learning training module 230 may train the session embedding model using the training data to generate initial values for the set of parameters of the session embedding model. The objective for training of the session embedding model may be prediction of the masked action based on minimization of a cross-entropy between consecutive actions in a sequence of actions. In one or more embodiments, the session embedding model is implemented as the Bidirectional Encoder Representations from Transformers (BERT) based transformer network. In one or more other embodiments, the session embedding model is implemented as the XLNet based machine-learning model.

Once the session embedding model is trained, the session embedding module 260 may deploy the session embedding model to infer an embedding for a current user’s session with the online system 140. The embedding for the current user’s session may be computed by loading a sequence of user’s actions in relation to the current session into the session embedding model (e.g., transformer network), and then pulling the embedding from an intermediate layer of the transformer network. In one or more embodiments, at inference, the SoftMax head of the transformer network is removed, and an intermediate layer of the transformer network is output as a session embedding. The session embedding generated by the session embedding model may be passed to the ranking module 270.

The ranking module 270 may integrate ranking machine-learning models that rank objects, such as web pages, items, ads, etc. The ranking module 270 may provide the session embedding generated by the session embedding model as an input signal to the ranking machine-learning models. The ranking machine-learning models may generate ranked content for presentation to the user, such as a web page with ranked sections, a ranked list of items, a ranked list of ads, etc. Outputs of the ranking machine-learning models may be provided to the content presentation module 210. The content presentation module 210 may use the outputs of the ranking machine-learning models to generate user interface signals with information about ranked content. The content presentation module 210 may send, via the network 130, the user interface signals to the user client device 100 causing the user client device 100 to display a user interface with ranked content, e.g., the web page with ranked sections, the ranked list of items, the ranked list of ads, etc.

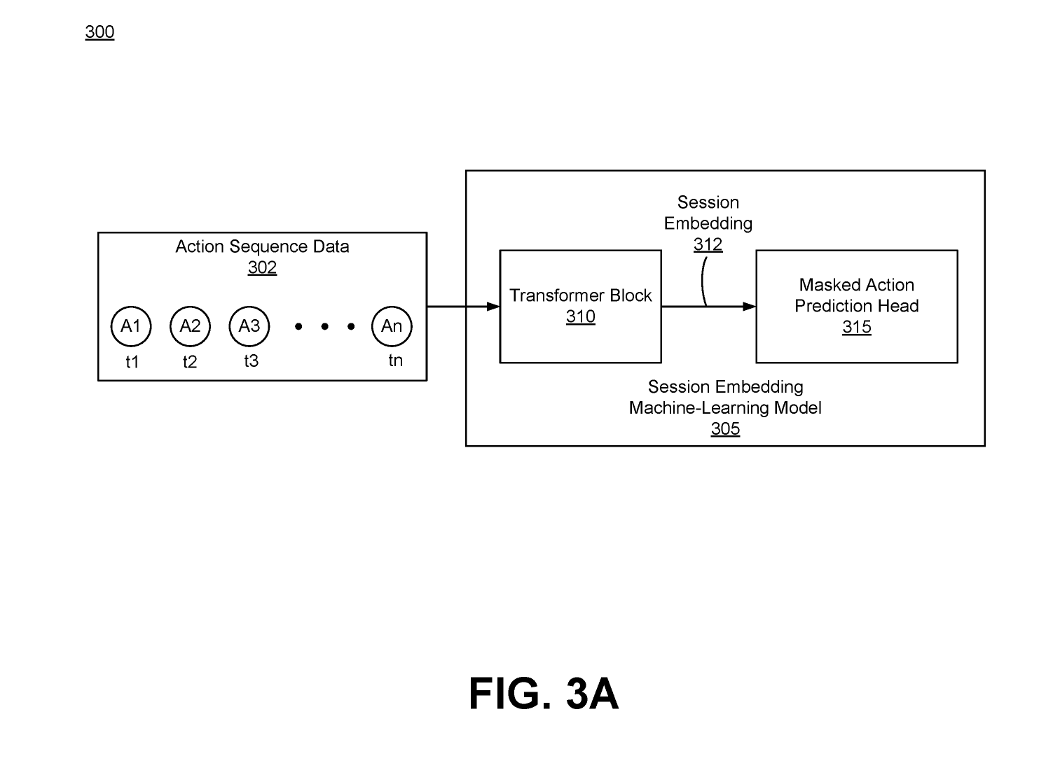

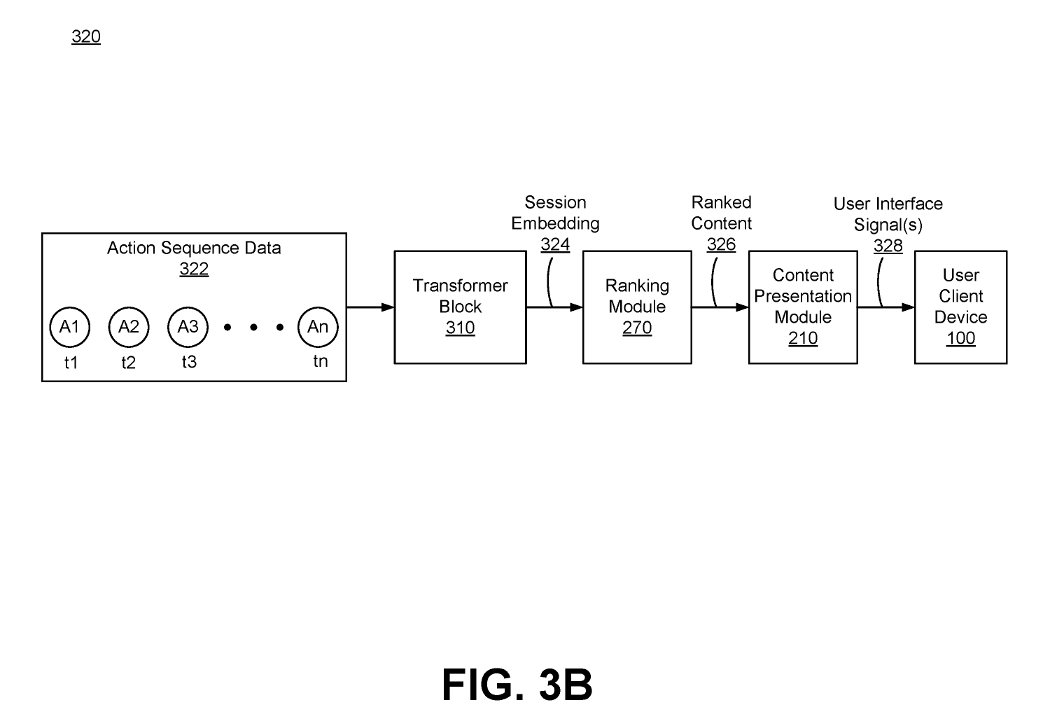

FIG. 3A illustrates an example architectural flow diagram 300 of training a session embedding machine-learning model 305 to generate an embedding for a session of a user with the online system 140, in accordance with one or more embodiments. The machine-learning training module 230 may retrieve (e.g., from the computer-readable medium of the session activity module 250) action sequence data 302 related to a past sequence of actions at the online system 140. The action sequence data 302 may include encoded data related to a user’s sequence of actions A1, A2, A3, …, An performed at time stamps t1, t2, t3, …, tn. The sequence of actions A1, A2, A3, …, An may be adding items to a cart, search queries, product views, etc. The action sequence data 302 may be passed to a transformer block 310 of the session embedding machine-learning model 305.

A set of parameters of the transformer block 310 may be trained to predict a next user’s action by applying the masked language modeling technique to the action sequence data 302. The action sequence data 302 represent training data, where a label is a masked action within the sequence of actions A1, A2, A3, …, An. The objective of the training is to perform a masked action prediction by minimizing a cross-entropy between consecutive actions in the sequence. During the training, the transformer block 310 may generate a session embedding 312 that encodes the sequence of actions A1, A2, A3, …, An, including the predicted user’s action. The transformer block 310 may represent a portion of the session embedding machine-learning model 305 including an intermediate layer that outputs the session embedding 312. The transformer block 310 may pass the session embedding 312 to a masked action prediction head 315 of the session embedding machine-learning model 305. The masked action prediction head 315 may perform the SoftMax function to the session embedding 312 to convert a vector of encoded numbers of the session embedding 312 that represent identifiers of actions into a probability distribution for the sequence of actions.

FIG. 3B illustrates an example architectural flow diagram 320 of using the trained session embedding machine-learning model 305 to generate in real time an embedding for a session of a user with the online system 140, in accordance with one or more embodiments. Once the session embedding machine-learning model 305 is trained, the online system 140 may deploy the session embedding machine-learning model 305 to infer an embedding for a current user’s session with the online system 140. The session activity module 250 may save action sequence data 322 related to a sequence of user’s actions during a current user’ session with the online system 140. The action sequence data 322 may include encoded data related to a user’s sequence of actions A1, A2, A3, …, An performed at time stamps t1, t2, t3, …, tn during the current user’ session with the online system 140. The sequence of actions A1, A2, A3, …, An may be adding items to a cart, search queries, product views, etc. The action sequence data 322 may be passed to the transformer block 310 of the trained session embedding machine-learning model 305.

The transformer block 310 may apply the machine-learning algorithm to the action sequence data 322 to generate a session embedding 324, i.e., the vector of data entries that encodes information about the user’s actions performed during the current user’ session with the online system 140. The transformer block 310 may pass the session embedding 324 to the ranking module 270.

The ranking module 270 may integrate multiple ranking machine-learning models that rank various objects, such as web pages, items, ads, etc. In one or more embodiments, the ranking module 270 integrates an item ranking machine-learning model trained to rank items, a web page ranking machine-learning model trained to rank content of web pages, and an ad ranking machine-learning model trained to rank ads. The ranking module 270 may further integrate one or more additional machine-learning models that can leverage session awareness represented by the session embedding 324. The ranking module 270 may provide the session embedding 324 as an input signal to the item ranking machine-learning model, the web page ranking machine-learning model, and/or the ad ranking machine-learning model. The item ranking machine-learning model, the web page ranking machine-learning model, and/or the ad ranking machine-learning model may generate ranked content 326 for presentation to the user, e.g., a ranked list of items, a web page with ranked sections, a ranked list of ads, etc. The ranking module 270 may pass the ranked content 326 to the content presentation module 210.

The content presentation module 210 may use the ranked content 326 to generate one or more user interface signals 328 with information about ranked content 326 (e.g., ranked list of items, web page with ranked sections, and/or ranked list of ads). The content presentation module 210 may send, via the network 130, the one or more user interface signals 328 to the user client device 100 causing the user client device 100 to display a user interface with the ranked content 326, e.g., the ranked list of items, the web page with ranked sections, and/or the ranked list of ads, etc.

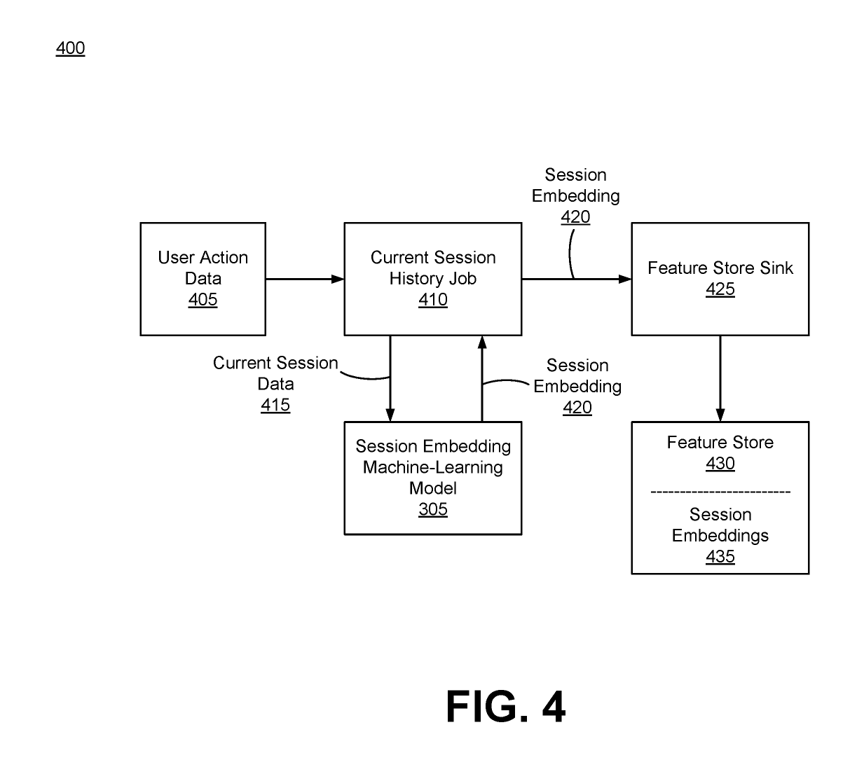

FIG. 4 illustrates an example architectural flow diagram 400 of a real-time pipeline that continually feeds a user’s actions into the trained session embedding machine-learning model 305 and updates the current session embedding in a feature store for other machine-learning models of the online system 140, in accordance with one or more embodiments. During a current user’s session with the online system 140, the session activity module 250 may save real-time data with information about a user’s action (e.g., adding an item to a cart, submitting a search query, or viewing a product details), i.e., user action data 405. The user action data 405 may be loaded to a current session history job 410 that represents a process that maintains data with information about the current session history, i.e., current session data 415. The current session history job 410 may pass the current session data 415 to the session embedding machine-learning model 305.

The session embedding machine-learning model 305 may apply the machine-learning algorithm to the current session data 415 to generate a session embedding 420 for the current session. The session embedding 420 may include encoded information about the current user’s session, as well as encoded information about a predicted next user’s action. It can be observed that, in this real-time pipeline, as the user is performing an action represented by the user action data 405, current session data 415 that includes the user action data 405 may be loaded into the session embedding machine-learning model 305. And each time the user action data 405 with information about a user’s action is loaded into the model, the session embedding 420 may be extracted from the session embedding machine-learning model 305, i.e., an intermediate layer (or the transformer block) of the session embedding machine-learning model 305. Thus, with each new action performed by the user, the session embedding machine-learning model 305 may infer a new session embedding 420. The session embedding machine-learning model 305 may pass the session embedding 420 back to the current session history job 410.

The current session history job 410 may then provide the newly inferred session embedding 420 to a feature store sink 425 that represents a gateway to a feature store 430. The feature store sink 425 may update the feature store 430 with the newly inferred session embedding 420, so that the newly inferred session embedding 420 is immediately available for other machine-learning models to use as needed, such as to rank content to show back to the user during the session. The feature store 430 may store the newly inferred session embedding 420 together with one or more previously generated session embedding for this specific user. The real-time pipeline illustrated in FIG. 4 may reduce latency, since the session embedding 420 is always available for the other machine-learning models to use, rather than having to generate a session embedding each time the session embedding is needed.

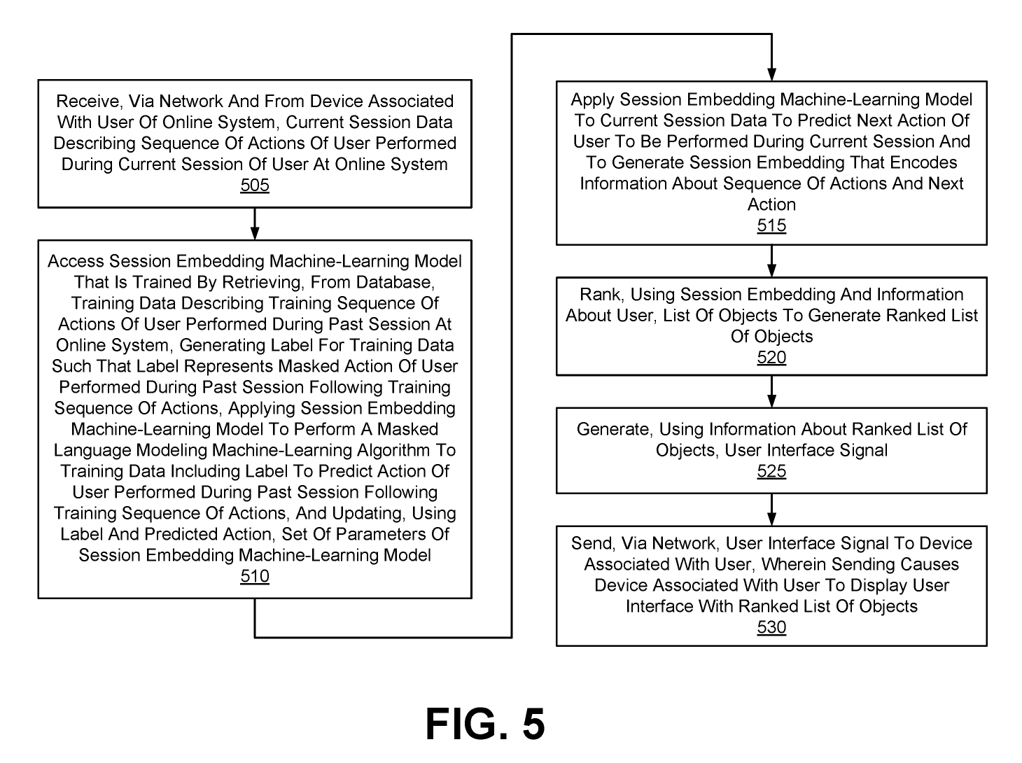

FIG. 5 is a flowchart for a method of training and using a machine-learning model of an online system to generate a session embedding, in accordance with one or more embodiments, in accordance with one or more embodiments. Alternative embodiments may include more, fewer, or different steps from those illustrated in FIG. 5, and the steps may be performed in a different order from that illustrated in FIG. 5. These steps may be performed by an online system (e.g., the online system 140). Additionally, each of these steps may be performed automatically by the online system without human intervention.

The online system 140 receives 505 (e.g., at the session activity module 250), via a network (e.g., the network 130) and from a device associated with a user of the online system 140 (e.g., the user client device 100), current session data describing a sequence of actions of the user performed during a current session of the user at the online system 140. The online system 140 may receive the current session data by receiving (e.g., at the session activity module 250), via the network and from the device associated with the user, interaction data including information about a specific interaction of the user with an object, the specific interaction representing a respective action from the sequence of actions. The online system 140 may receive (e.g., at the session activity module 250) the interaction data including information about the user adding an item to a cart that represents the specific interaction of the user with the object. Alternatively, the online system 140 may receive (e.g., at the session activity module 250) the interaction data including information about the user submitting a search query via the user interface of the device associated with the user, the user submitting the search query representing the specific interaction of the user with the object.

The online system 140 accesses 510 a session embedding machine-learning model of the online system 140, e.g., via the session embedding module 260. The session embedding machine-learning model is trained (e.g., via the machine-learning training module 230 and the session embedding module 260) by: retrieving (e.g., via the machine-learning training module 230), from a database of the online system 140 (e.g., the data store 240), training data describing a training sequence of actions of the user performed during a past session of the user at the online system 140, generating (e.g., via the machine-learning training module 230) a label for the training data such that the label represents a masked action of the user performed during the past session, the masked action following the training sequence of actions, applying the session embedding machine-learning model (e.g., via the session embedding module 260) to perform a masked language modeling machine-learning algorithm to the training data including the label to predict an action of the user performed during the past session, the predicted action following the training sequence of actions, and updating (e.g., via the machine-learning training module 230), using the label and the predicted action, a set of parameters of the session embedding machine-learning model.

The online system 140 may retrieve (e.g., via the machine-learning training module 230), from the database, interaction data including information about a specific interaction of the user with an object, the specific interaction representing a respective action from the training sequence of actions. More specifically, the online system 140 may retrieve (e.g., via the machine-learning training module 230), from the database, interaction data including information about the user converted on an item or information that the user submitted a search query via the user interface of the device associated with the user.

The online system 140 applies 515 the session embedding machine-learning model (e.g., via the session embedding module 260) to the current session data to predict a next action of the user to be performed during the current session, the next action following the sequence of actions, and generate a session embedding that encodes information about the sequence of actions and the next action. The online system 140 may load (e.g., via the session embedding module 260) the current session data to the session embedding machine-learning model implemented as a transformer network model comprising a plurality of network layers. The online system 140 may generate, by an intermediate layer of the plurality of network layers and using the current session data, the session embedding.

The online system 140 ranks 520 (e.g., via the ranking module 270), using the session embedding and information about the user, a list of objects to generate a ranked list of objects. The online system 140 generates 525 (e.g., via the content presentation module 210), using information about the ranked list of objects, a user interface signal. The online system 140 sends 530 (e.g., via the content presentation module 210), via the network, the user interface signal to the device associated with the user, wherein the sending the user interface signal causes the device associated with the user to display a user interface with the ranked list of objects.

The online system 140 may rank the list of objects by applying a web page ranking machine-learning model (e.g., via the ranking module 270) to the session embedding and information about a plurality of sections of a webpage to generate a version of the webpage including a plurality of ranked sections. In such cases, the online system 140 may send (e.g., via the content presentation module 210) the user interface signal to the device associated with the user causing the device associated with the user to display the user interface with the version of the webpage including the plurality of ranked sections.

The online system 140 may rank the list of objects by applying an item ranking machine-learning model (e.g., via the ranking module 270) to the session embedding and information about a plurality of items to generate a plurality of ranked items. In such cases, the online system 140 may send (e.g., via the content presentation module 210) the user interface signal to the device associated with the user causing the device associated with the user to display the user interface with the plurality of ranked items.

The online system 140 may receive (e.g., at the session activity module 250), via the network and from the device associated with the user, action data with information about an action of the user performed during the current session. The online system 140 may apply the session embedding machine-learning model (e.g., via the session embedding module 260) to the current session data and the action data to predict a second action to be performed by the user during the current session, the second action following the action, and generate an updated version of the session embedding further encoding information about the action and the second action. The online system 140 may update (e.g., via the order management module 220) a feature store of the online system 140 (e.g., part of the order management module 220) by replacing the session embedding with the updated version of the session embedding. The online system 140 may load (e.g., via the ranking module 270), from the feature store, the updated version of the session embedding. The online system 140 may rank (e.g., via the ranking module 270), using the updated version of the session embedding, the ranked list of objects to generate an updated version of the ranked list of objects. The online system 140 may generate (e.g., via the content presentation module 210), using information about the updated version of the ranked list of objects, a second user interface signal. The online system 140 may send (e.g., via the content presentation module 210), via the network, the second user interface signal to the device associated with the user, wherein the sending the second user interface signal causes the device associated with the user to display the user interface with the updated version of the ranked list of objects.

Embodiments of the present disclosure are directed to the online system 140 that trains and utilizes a machine-learning model (i.e., transformer network) to generate an embedding in real time for a current session of a user with the online system 140. A session embedding is generated using a transformer network trained to predict a next user’s action. User’s actions performed during a current session are loaded into the trained transformer network to produce the session embedding from a layer in the transformer network. The transformer network is trained using the masked language modeling technique. The online system 140 further integrates the real-time pipeline that makes the session embedding always available for other services that use the session embedding as an input feature, such as ranking machine-learning models trained to rank various content for presentation to the user during the current user’s session.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a network and from a device associated with a user of an online system, current session data describing a sequence of actions of the user performed during a current session of the user at the online system;
accessing a session embedding machine-learning model of the online system, wherein the session embedding machine-learning model is trained by:
retrieving, from a database of the online system, training data describing a training sequence of actions of the user performed during a past session of the user at the online system,
generating a label for the training data such that the label represents a masked action of the user performed during the past session, the masked action following the training sequence of actions,
applying the session embedding machine-learning model to perform a masked language modeling machine-learning algorithm to the training data including the label to predict an action of the user performed during the past session, the predicted action following the training sequence of actions, and
updating, using the label and the predicted action, a set of parameters of the session embedding machine-learning model;
applying the session embedding machine-learning model to the current session data to:
predict a next action of the user to be performed during the current session, the next action following the sequence of actions, and
generate a session embedding that encodes information about the sequence of actions and the next action;
ranking, using the session embedding and information about the user, a list of objects to generate a ranked list of objects;
generating, using information about the ranked list of objects, a user interface signal; and
sending, via the network, the user interface signal to the device associated with the user, wherein the sending the user interface signal causes the device associated with the user to display a user interface with the ranked list of objects.

2. The method of claim 1, wherein receiving the current session data comprises:
receiving, via the network and from the device associated with the user, interaction data including information about a specific interaction of the user with an object, the specific interaction representing a respective action from the sequence of actions.

3. The method of claim 2, wherein receiving the interaction data comprises:
receiving the interaction data including information about the user adding an item to a cart that represents the specific interaction of the user with the object.

4. The method of claim 2, wherein receiving the interaction data comprises:
receiving the interaction data including information about the user submitting a search query via the user interface of the device associated with the user, the user submitting the search query representing the specific interaction of the user with the object.

5. The method of claim 1, wherein retrieving the training data comprises:
retrieving, from the database, interaction data including information about a specific interaction of the user with an object, the specific interaction representing a respective action from the training sequence of actions.

6. The method of claim 1, wherein retrieving the training data comprises:
retrieving, from the database, interaction data including information about the user converted on an item or information that the user submitted a search query via the user interface of the device associated with the user.

7. The method of claim 1, wherein applying the session embedding machine-learning model comprises:
loading the current session data to the session embedding machine-learning model implemented as a transformer network model comprising a plurality of network layers; and
generating, by an intermediate layer of the plurality of network layers and using the current session data, the session embedding.

8. The method of claim 1, wherein:
ranking the list of objects comprises applying a web page ranking machine-learning model to the session embedding and information about a plurality of sections of a webpage to generate a version of the webpage including a plurality of ranked sections; and
sending the user interface signal causes the device associated with the user to display the user interface with the version of the webpage including the plurality of ranked sections.

9. The method of claim 1, wherein:
ranking the list of objects comprises applying an item ranking machine-learning model to the session embedding and information about a plurality of items to generate a plurality of ranked items; and
sending the user interface signal causes the device associated with the user to display the user interface with the plurality of ranked items.

10. The method of claim 1, further comprising:
receiving, via the network and from the device associated with the user, action data with information about an action of the user performed during the current session;
applying the session embedding machine-learning model to the current session data and the action data to:
predict a second action to be performed by the user during the current session, the second action following the action, and
generate an updated version of the session embedding further encoding information about the action and the second action; and
updating a feature store of the online system by replacing the session embedding with the updated version of the session embedding.

11. The method of claim 10, further comprising:
loading, from the feature store, the updated version of the session embedding;
ranking, using the updated version of the session embedding, the ranked list of objects to generate an updated version of the ranked list of objects;
generating, using information about the updated version of the ranked list of objects, a second user interface signal; and
sending, via the network, the second user interface signal to the device associated with the user, wherein the sending the second user interface signal causes the device associated with the user to display the user interface with the updated version of the ranked list of objects.

12. A computer program product comprising a non-transitory computer readable storage medium having instructions encoded thereon that, when executed by a processor, cause the processor to perform steps comprising:
receiving, via a network and from a device associated with a user of an online system, current session data describing a sequence of actions of the user performed during a current session of the user at the online system;
accessing a session embedding machine-learning model of the online system, wherein the session embedding machine-learning model is trained by:
retrieving, from a database of the online system, training data describing a training sequence of actions of the user performed during a past session of the user at the online system,
generating a label for the training data such that the label represents a masked action of the user performed during the past session, the masked action following the training sequence of actions,
applying the session embedding machine-learning model to perform a masked language modeling machine-learning algorithm to the training data including the label to predict an action of the user performed during the past session, the predicted action following the training sequence of actions, and
updating, using the label and the predicted action, a set of parameters of the session embedding machine-learning model;
applying the session embedding machine-learning model to the current session data to:
predict a next action of the user to be performed during the current session, the next action following the sequence of actions, and
generate a session embedding that encodes information about the sequence of actions and the next action;
ranking, using the session embedding and information about the user, a list of objects to generate a ranked list of objects;
generating, using information about the ranked list of objects, a user interface signal; and
sending, via the network, the user interface signal to the device associated with the user, wherein the sending the user interface signal causes the device associated with the user to display a user interface with the ranked list of objects.

13. The computer program product of claim 12, wherein the instructions further cause the processor to perform steps comprising:
receiving the current session data by receiving, via the network and from the device associated with the user, interaction data including information about a specific interaction of the user with an object, the specific interaction representing a respective action from the sequence of actions.

14. The computer program product of claim 13, wherein the instructions further cause the processor to perform steps comprising:
receiving the interaction data including information about the user adding an item to a cart that represents the specific interaction of the user with the object, or receiving the interaction data including information about the user submitting a search query via the user interface of the device associated with the user, the user submitting the search query representing the specific interaction of the user with the object.

15. The computer program product of claim 12, wherein the instructions further cause the processor to perform steps comprising:
retrieving the training data by retrieving, from the database, interaction data including information about a specific interaction of the user with an object, the specific interaction representing a respective action from the training sequence of actions.

16. The computer program product of claim 12, wherein the instructions further cause the processor to perform steps comprising:
loading the current session data to the session embedding machine-learning model implemented as a transformer network model comprising a plurality of network layers; and
generating, by an intermediate layer of the plurality of network layers and using the current session data, the session embedding.

17. The computer program product of claim 12, wherein the instructions further cause the processor to perform steps comprising:
ranking the list of objects by applying an item ranking machine-learning model to the session embedding and information about a plurality of items to generate a plurality of ranked items; and
sending the user interface signal causes the device associated with the user to display the user interface with the plurality of ranked items.

18. The computer program product of claim 12, wherein the instructions further cause the processor to perform steps comprising:
receiving, via the network and from the device associated with the user, action data with information about an action of the user performed during the current session;
applying the session embedding machine-learning model to the current session data and the action data to:
predict a second action to be performed by the user during the current session, the second action following the action, and
generate an updated version of the session embedding further encoding information about the action and the second action; and
updating a feature store of the online system by replacing the session embedding with the updated version of the session embedding.

19. The computer program product of claim 18, wherein the instructions further cause the processor to perform steps comprising:
loading, from the feature store, the updated version of the session embedding;
ranking, using the updated version of the session embedding, the ranked list of objects to generate an updated version of the ranked list of objects;
generating, using information about the updated version of the ranked list of objects, a second user interface signal; and
sending, via the network, the second user interface signal to the device associated with the user, wherein the sending the second user interface signal causes the device associated with the user to display the user interface with the updated version of the ranked list of objects.

20. A computer system comprising:
a processor; and
a non-transitory computer-readable storage medium having instructions that, when executed by the processor, cause the computer system to perform steps comprising:
receiving, via a network and from a device associated with a user of an online system, current session data describing a sequence of actions of the user performed during a current session of the user at the online system;
accessing a session embedding machine-learning model of the online system, wherein the session embedding machine-learning model is trained by:
retrieving, from a database of the online system, training data describing a training sequence of actions of the user performed during a past session of the user at the online system,
generating a label for the training data such that the label represents a masked action of the user performed during the past session, the masked action following the training sequence of actions,
applying the session embedding machine-learning model to perform a masked language modeling machine-learning algorithm to the training data including the label to predict an action of the user performed during the past session, the predicted action following the training sequence of actions, and
updating, using the label and the predicted action, a set of parameters of the session embedding machine-learning model;
applying the session embedding machine-learning model to the current session data to:
predict a next action of the user to be performed during the current session, the next action following the sequence of actions, and
generate a session embedding that encodes information about the sequence of actions and the next action;
ranking, using the session embedding and information about the user, a list of objects to generate a ranked list of objects;
generating, using information about the ranked list of objects, a user interface signal; and
sending, via the network, the user interface signal to the device associated with the user, wherein the sending the user interface signal causes the device associated with the user to display a user interface with the ranked list of objects.
